(19) United States
(12) Patent Application Publication
(10) Pub. No.: US 2003/0101420 A1
(43) Pub. Date: May 29, 2003

(54) Method and device for the automatic allocation of at least one identification data set for at least one component of a technical system

(76) Inventors: Michael Von Kamp, Munchen (DE); Jorg Peter, Eresing (DE)

Correspondence Address: LERNER AND GREENBERG, P.A., Post Office Box 2480, Hollywood, FL, 33022-2480, US

(21) Appl. No.: 10/306,183

(22) Filed: Nov. 27, 2002

(30) Foreign Application Priority Data
Nov. 29, 2001 (DE) 101 59 840.8

(51) Int. Cl. G06F 17/50

(52) U.S. Cl. 716/1

(57) ABSTRACT

A method and a device automatically allocate at least one identification data set for at least one component of a technical system, in particular a circuit element of a semiconductor component. A graphical association between at least one identification data set and at least one component is automatically produced in a display area of a monitor. The graphical association is independent of the selection of the view of the component in the display area. Processing of extended components is therefore possible in a simple way, even in changing views.

### BACKGROUND OF THE INVENTION

### FIELD OF THE INVENTION

The invention relates to a method for automatic allocation of at least one identification data set for at least one component of a technical system, in particular a circuit element of a semiconductor component. The invention further pertains to a device for implementing such a method.

During the design or the simulation of technical systems by way of data processing devices, it is frequently not possible to indicate all the components of the system at once in a display area, since the technical system is too extended. Technical systems can be, for example, pipeline systems of chemical plants, buildings or electronic circuit diagrams or layouts.

Typical of these is the design of a layout of circuit elements, such as bus lines, of a semiconductor component. In this case, by using programs (e.g. Cadence Virtuoso®), any desired detail of a layout can be viewed and edited. Because of the increase in complexity of the layouts, there is generally a large number of circuit elements in the display area of a monitor. For the designer there is in this case the difficulty of knowing the identity of the respective circuit elements. For the purpose of identification, a circuit element is normally provided with a label. If, however, the display area of the monitor changes, for example as a result of scrolling, then this label disappears out of the display area under certain circumstances, so that the designer has to allocate a new label or has to attempt to remember the correct allocation. Both are associated with some effort.

### SUMMARY OF THE INVENTION

It is accordingly an object of the invention to provide a method and a device which overcomes the above-mentioned disadvantages of the heretofore-known devices and methods of this general type and which render the processing of extended components readily possible, even in the event of changing views.

With the foregoing and other objects in view there is provided, in accordance with the invention, a method of automatically allocating at least one identification data set for at least one component of a technical system. The novel method comprises automatically producing a graphical association between at least one identification data set and at least one component in a display area of a display monitor, with the graphical association being independent of a selected view of the at least one component in the display area of the display monitor.

In a preferred embodiment of the invention, the technical system is a semiconductor component and the at least one component is a circuit element of the semiconductor component.

The fact that a graphical association between at least one identification data set and at least one component is produced automatically in a display area of a monitor, the graphical association being independent of the choice of the view of the component in the display area, a designer is able to follow the association of the component, even in the event of changing display areas.

In order to increase the clarity, at least one identification data set is advantageously arranged on or beside the at least one component.

At least one identification data set advantageously additionally has data relating to the operating state of the respectively associated component element. Therefore, in addition to an association of a specific function of a component, an operating state can also be displayed in a simulation.

It is particularly advantageous for at least one circuit element to be, as component, a part of a layout, in particular a bus of a semiconductor component. In this type of layout, particularly extended components arise, so that automatic graphical allocation is of particular importance.

In accordance with an added feature of the invention, at least one graphical display of the identification data set and the association with the respective component automatically remain visible in the display area when the display area is scrolled.

Furthermore, it is advantageous if, when building up a view of components in a display area, all or a predetermined subset of the components visible in the display area is/are determined and these are then automatically provided with an identification data set which is visible in the display area. In order to preserve the clarity, it may be expedient not to provide all the possible components in the display area with an identification data set, but only a subset of said components. The subset is, for example, defined by means of specific design parameters, so that only the components which have these design parameters are displayed.

It is also advantageous if the visible arrangement of the identification data sets for components is carried out in the region of the point of intersection of the components with the boundaries of the display area.

There is also provided, in accordance with the invention, a computer-readable medium with computer-executable instructions for performing the above-outlined method according to the invention.

With the above and other objects in view there is also provided, in accordance with the invention, a device for automatically allocating at least one identification data set for at least one component of a technical system, in particular of a semiconductor circuit. The device comprises:

a component database containing at least one component (e.g., circuit elements of semiconductor components) linked uniquely with an identification data set;

an allocation device for automatically producing a graphical association between at least one identification data set and at least one component in a display area of a display monitor, wherein the association is independent of a selected view of the component in the display area.

With the above and other objects in view there is also provided, in accordance with the invention, a display driver for a display monitor that contains this device.

In the component database, in particular for circuit elements of semiconductor components, at least one component is linked uniquely with an identification data set. In a display area of a monitor, an allocation means automatically produces a graphical association between at least one identification data set and at least one component. The association is independent of the choice of the view of the component in the display area.

Other features which are considered as characteristic for the invention are set forth in the appended claims.

Although the invention is illustrated and described herein as embodied in a method and device for automatic allocation of at least one identification data set for at least one component of a technical system, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a schematic view of a circuit layout with a graphical representation of an identification data set for a circuit element at a first time;

FIG. 2 is a schematic view of the circuit layout of FIG. 1 with a changed display area; and

FIG. 3 is a block diagram illustrating a device for carrying out the method of the invention.

### DESCRIPTION OF THE PREFERRED EMBODIMENTS

In the following text, the method according to the invention and the device according to the invention will be described with reference to the layout for a semiconductor component. In principle, however, the method and the device can also be applied to other layouts, such as pipeline plans of process plants, wherein components 1 are considered which are so extended that they cannot be displayed as a whole in a display area 10 of a monitor.

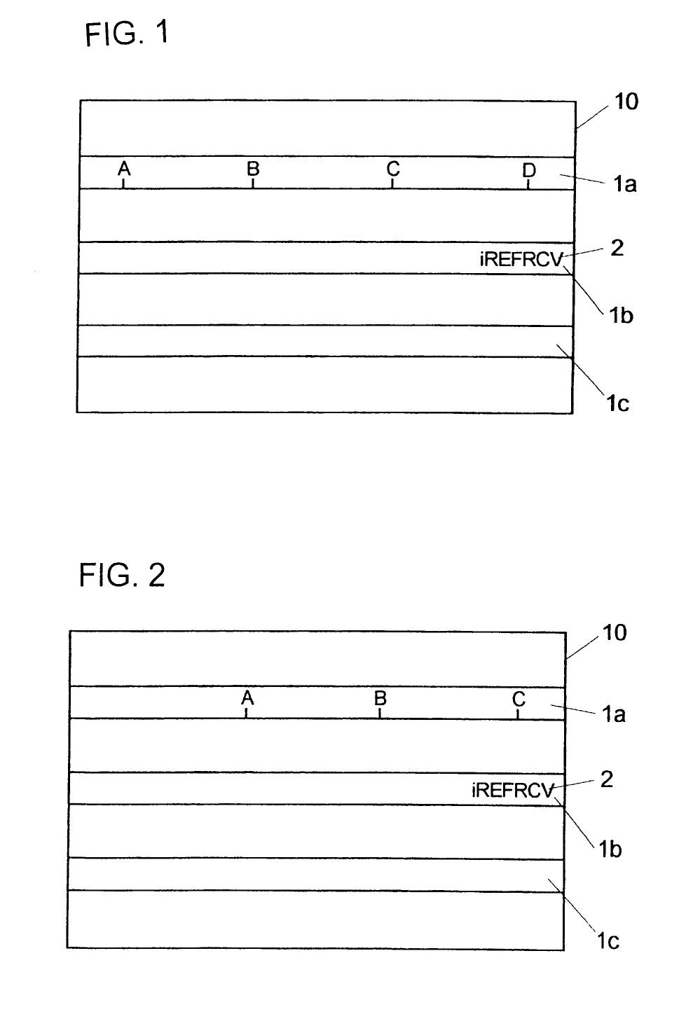

Referring now to the figures of the drawing in detail and first, particularly, to FIG. 1 thereof, there is shown a display area 10 which, schematically and as a detail, shows bus lines 1a, 1b, 1c as circuit elements of a semiconductor component. In the sense of the invention, the circuit elements are the components.

A display area 10 of this type normally results during design and simulation programs, such as in Cadence Virtuoso®.

In order to make the method according to the invention clear, the circuit elements 1a, 1b, 1c are deliberately laid out simply, specifically linearly. The circuit element 1b automatically shows at the edge of the display area 10 a display of an identification data set 2. The marking indicates which function the circuit element 1b has.

The identification data set 2 is stored in an identification database belonging to the device according to the invention, said database containing an unambiguous association between all the circuit elements 1a, 1b, 1c and corresponding functional data.

In addition the identification database can also have information about a respective operating state (for example in simulation programs) or physical dimensions of the circuit element 1a, 1b, 1c. In addition, different possible displays of the graphical association can be selected, for example lines which connect the display to the circuit element 1.

In order to clarify the change in the view in the display area (see FIG. 2), markings A, B, C, D are applied to the top circuit element 1a.

In the example shown here, in order to process the layout, the view of the circuit elements 1a, 1b, 1c is shifted to the right, that is to say the marking D disappears at the right-hand edge of the display area 10.

The method according to the invention uses the unambiguous association between circuit element 1b and the identification data set 2 to the end that the display of the identification data set 2 automatically remains graphically connected (that is to say graphically associated) with the circuit element 1b. The display of the identification data set 2 is therefore independent of the respectively set display area 10.

In the present case, the display of the identification data set 2 within the circuit element 1b remains at the right-hand edge of the display area. Alternatively, the display of the identification data set 2 can also be presented beside the circuit element 1b, a thin connecting line to the circuit element 1b then being generated automatically.

In the event of a change in the display area 10, the method according to the invention automatically determines all the circuit elements 1a, 1b, 1c which are visible in the changed display area. At the same time, it is automatically determined where which circuit element 1 is cut by the edge of the display area.

Then, a comparison with the identification database is carried out by an allocation means, a corresponding display of the identification data set 2 being displayed in relation to all the circuit elements 1a, 1b, 1c that are visible in the display area 10. In the event of a change in the display area 10, these steps are repeated.

By means of parameters, i.e. by parameterization, it is possible to display only specific displays of identification data sets 2, which can lead to an increase in the clarity.

The automatic allocation and display of the identification data set 2 means that a designer more easily retains the overview of the layout, particularly when he is viewing only a detail of an extended layout, the detail being shifted continually.

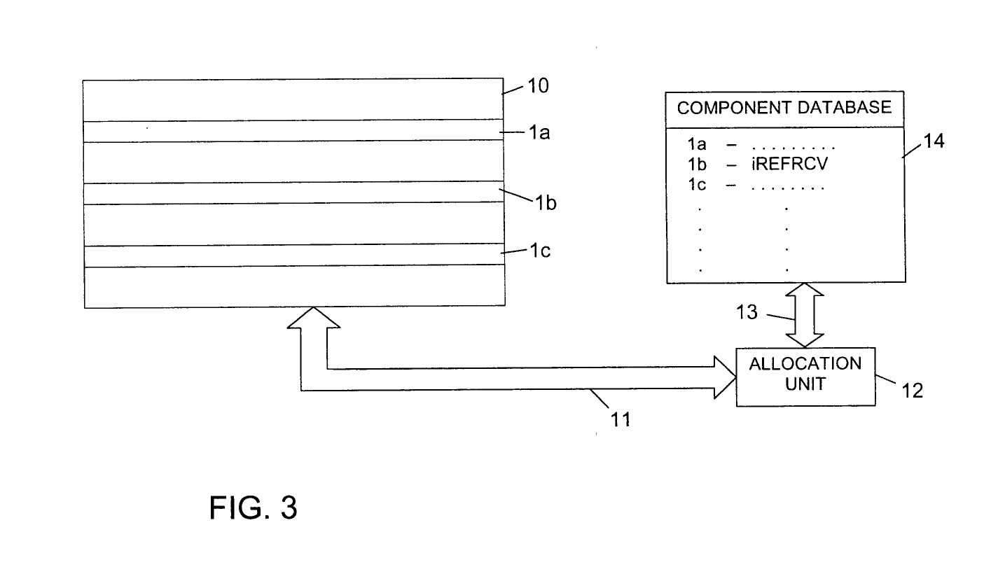

In terms of its implementation, the invention is not restricted to the preferred exemplary embodiments specified above. Instead, a number of variants are conceivable which make use of the method according to the invention and the device according to the invention, even in designs of fundamentally different types. The primary components of the novel device for implementing the method are illustrated in the block diagram of FIG. 3. There, the display area 10 in the display monitor is linked via a bus 11 with an allocation unit 12. The allocation unit 12 automatically effects the graphical allocation between the at least one identification data set 2 and the at least one component 1 in the display area 10. The allocation unit 12 is connected via a bus 13 (either an internal bus or the same bus 11) to a component database 14. The component database 14 contains components such as, for instance, circuit elements of a semiconductor component, elements of a piping system in a chemical processing plant, or the like. In the component database 14 the components 1a, 1b, 1c are uniquely linked with an identification dataset 2. As illustrated, the dataset iREFRCV is linked with the component 1b.

We claim:

1. A method of automatically allocating at least one identification data set for at least one component of a technical system, which comprises:
automatically producing a graphical association between at least one identification data set and at least one component in a display area of a display monitor, with the graphical association being independent of a selected view of the at least one component in the display area of the display monitor.

2. The method according to claim 1, wherein the at least one component is a circuit element of a semiconductor component.

3. The method according to claim 1, which comprises automatically arranging the at least one identification data set at or beside the at least one component.

4. The method according to claim 1, wherein the at least one identification data set additionally contains data relating to an operating state of a respectively associated component.

5. The method according to claim 1, wherein the at least one component is a circuit element.

6. The method according to claim 5, wherein the circuit element forms a part of a layout of the technical system.

7. The method according to claim 2, wherein the circuit element represents a bus of the semiconductor component.

8. The method according to claim 1, which comprises, when the display area is scrolled, retaining at least one graphical display of the identification data set and the association with the respective component displayed in the display area.

9. The method according to claim 1, which comprises, during a construction of a view of components in a display area, determining all the components visible in the display area, and automatically providing all the components visible in the display area with an identification data set visible in the display area.

10. The method according to claim 9, which comprises arranging the identification data sets for the components in an area of a point of intersection of the components with a boundary of the display area.

11. A device for automatically allocating at least one identification data set for at least one component of a technical system, comprising:
a component database containing at least one component linked uniquely with an identification data set;
an allocation device for automatically producing a graphical association between at least one identification data set and at least one component in a display area of a display monitor, wherein the association is independent of a selected view of the component in the display area.

12. The device according to claim 11, wherein the technical system is a semiconductor component and said component database contains circuit elements of semiconductor components.

13. In a display driver for a display monitor, the device according to claim 11.

14. A computer-readable medium having computer-executable instructions for performing the method according to claim 1.
